(19) United States
(12) Patent Application Publication
(10) Pub. No.: US 2009/0077038 A1
(43) Pub. Date: Mar. 19, 2009

(54) Methods and Systems for Verifying the Identity of a Subject of a Dictation Using Text to Speech Conversion and Playback

(75) Inventors: James M. Dolbey, JR., Cincinnati, OH (US); Curtis A. Weeks, Loveland, OH (US); Matthew Knapp, Milford, OH (US); Holly Dolbey, Haslett, MI (US)

Correspondence Address: DINSMORE & SHOHL, LLP, 1900 CHEMED CENTER, 255 EAST FIFTH STREET, CINCINNATI, OH, 45202, US

(73) Assignee: DOLBEY AND COMPANY, Cincinnati, OH (US)

(21) Appl. No.: 12/212,485

(22) Filed: Sep. 17, 2008

Related U.S. Application Data
(60) Provisional application No. 60/973,310, filed on Sep. 18, 2007.

(51) Int. Cl. G06F 17/30

(52) U.S. Cl. 707/3; 707/E17.135

(57) ABSTRACT

A method for audibly verifying the identity of a subject while dictating a report with a system comprising an input device and a computer includes entering alpha-numeric indicia into the system with the input device where the alpha-numeric indicia are related to the identity of the subject of the dictation. The entered alpha-numeric indicia are transmitted from the system to a records database coupled to the computer. Subject identifiers are received by the system when a record is found in the records database which has identifying indicia corresponding to the entered alpha-numeric indicia. The subject identifiers associated with the record are audibly communicated to a user of the system. The user of the system may use the audibly communicated subject identifiers to verify that the entered alpha-numeric indicia correspond to the subject on which the dictation is being performed.

### CROSS REFERENCE TO RELATED APPLICATIONS

This application claims priority to U.S. Provisional Patent Application Ser. No. 60/973,310 filed Sep. 18, 2007 and entitled “PATIENT VERIFICATION USING TEXT TO SPEECH PLAYBACK.”

### TECHNICAL FIELD

The present invention is directed to methods and systems for dictation and, more specifically, to methods and systems of providing audible verification of the identity of a subject of a dictation to a user dictating a report.

### BACKGROUND

A system for dictating medical records generally requires that the physician or health care provider enter some alpha-numeric indicia which are related or linked to the identity of the patient. For example, the alpha-numeric indicia may be arbitrarily or randomly assigned indicia such as a medical record number, patient account number, order number, token ID, visit ID, and the like. Alternatively, the alpha-numeric indicia may include non-random alpha-numeric indicia, such as the patient name, date of birth, social security number, etc. Alternatively, the alpha-numeric indicia may include any combinations and/or portions of such arbitrarily, randomly assigned, or non-random indicia. The entry of such information is often done on a key pad, such as when the dictation is performed via telephone, mobile phone, personal digital assistant (PDA), or a similar device, or on a keyboard, as when the dictation is performed via computer, or similar device, or verbally via a microphone, telephone or similar device. For example, the physician may enter the medical record number 12345 on a telephone keypad when prompted by the system. While dictating the medical report, the physician also will typically state the patient's name at the outset of the dictation indicating that the physician is dictating a report for patient “John Smith.” Upon completing the dictated report, the recorded dictation is typically stored in a digital format and made available to a transcriptionist for transcription.

One problem with current systems is that they do not provide an easy way for the dictating physician to confirm that the alpha-numeric indicia entered by the physician corresponds to the patient whose medical record the physician is dictating. In other words, when the dictating physician enters the alpha-numeric indicia during the dictation process, the physician has no way to confirm that the alpha-numeric indicia were accurately typed or that the alpha-numeric indicia correspond to the patient for whom the physician is dictating the report. Instead, current systems often rely on the transcriptionist or another person, and not the person dictating the report, to confirm the identity of the patient following dictation. For example, when the transcriptionist receives the recorded dictation, he or she must verify that the alpha-numeric indicia provided by the physician are valid and that they correspond to the dictated patient name, often requiring the transcriptionist to access a database of patient information. If the alpha-numeric indicia are invalid or do not correspond to the dictated patient name, the transcriptionist must correct the error.

Another problem with current systems is that they may require a dictated report to contain, or be linked to a file that contains, a patient name or other patient demographic information. This patient information is disclosed to the transcriptionist, who may use the information to ensure that the transcribed report is posted to the correct patient file. Disclosure of such patient information to the transcriptionist is of particular concern in situations where the transcription is performed by a third party, or overseas.

Another problem exists in cases where the transcriptionist does not have access to information disclosing patient identity and/or the transcriptionist is not responsible for correlating the dictated report with the correct patient. For example, in some health care settings, the transcriptionist will not have access to information disclosing the identity of the patient for whom medical records are being transcribed. Rather, the transcriptionist might receive only a number or alpha-numeric set such as a unique token, without receiving any patient identifying information or even the dictated patient name. Likewise, the transcriptionist may not have access to a database from which s/he can retrieve information relating to patient identity. In such cases, correlation of the alpha-numeric indicia entered by the physician during dictation may occur only after the transcriptionist completes transcription. The correlation process may be performed automatically by the system, by another person, or by a combination of both. In some cases, no such correlation might occur, and the transcribed medical report simply will be posted to whatever file corresponds to the alpha-numeric indicia provided by the physician during dictation. If the physician incorrectly entered the alpha-numeric indicia, additional correlation efforts on the part of the system and/or a person may be necessary and could result in the transcribed report being posted to the wrong patient medical record.

Accordingly, a need exists for methods and systems for dictating a report in which the person dictating the report can easily verify the identity of the subject of the dictation during the dictation process.

### SUMMARY OF THE INVENTION

In one embodiment, a method for audibly verifying the identity of a subject while dictating a report with a system comprising an input device and a computer includes entering alpha-numeric indicia into the system with the input device where the alpha-numeric indicia are related to the identity of the subject of the dictation. The entered alpha-numeric indicia are transmitted from the system to a records database coupled to the computer. Subject identifiers are received by the system when a record is found in the records database which has identifying indicia corresponding to the entered alpha-numeric indicia. The subject identifiers associated with the record are audibly communicated to a user of the system. The user of the system may use the audibly communicated subject identifiers to verify that the entered alpha-numeric indicia correspond to the subject on which the dictation is being performed. The system may be operable to receive dictation from a user and audibly communicate the subject identifiers to the user.

In another embodiment, a method for verifying an identity of a subject of a dictation process in a system includes receiving alpha-numeric indicia from the system, wherein the alpha-numeric indicia are related to the identity of the subject of the dictation. Thereafter, the alpha-numeric indicia are used to search a records database for a record having identifying indicia corresponding to the received alpha-numeric indicia. When a record having identifying indicia corresponding to the received alpha-numeric indicia is found in the records database, subject identifiers associated with the record are transmitted to the system. The system may be operable to receive dictation from a user and audibly communicate the subject identifiers to a user.

In another embodiment, a system operable to verify an identity of a subject of a dictation process includes an input device and a computer. The input device may be coupled to the computer and may be operable to input alpha-numeric indicia received from a user into the computer. The alpha-numeric indicia may be related to the identity of the subject of the dictation. The computer may be coupled to a records database and may be operable to transmit the alpha-numeric indicia to the records database and thereby initiate a search of the records database for a record having identifying indicia corresponding to the alpha-numeric indicia received from the input device. The computer may also be operable to receive subject identifiers associated with the record when a record having identifying indicia corresponding to the alpha-numeric indicia is found in the records database. The computer may also be operable to audibly communicate the subject identifiers to the user of the system and thereby enable the user of the system to verify the identity of the subject of the dictation. The computer may also be operable to notify the user of the system when a record having identifying indicia corresponding to the alpha-numeric indicia is not found.

In yet another embodiment, a computer readable medium includes an executable instruction set for use in conjunction with a system comprising an input device and a computer. When the executable instruction set is executed by the computer, the executable instruction set causes the computer to prompt a user to enter alpha-numeric indicia into the input device, wherein the alpha-numeric indicia are related to the identity of a subject of a dictation. After the alpha-numeric indicia are entered into the input device, the computer executable instruction set causes the computer to transmit the alpha-numeric indicia to a records database coupled to the computer and thereby initiate a search of the records database for a record having identifying indicia corresponding to the entered alpha-numeric indicia. When a record having identifying indicia corresponding to the alpha-numeric indicia is found, the computer receives subject identifiers associated with the record from the records database and the executable instruction set causes the computer to audibly communicate the subject identifiers associated with the record to a user of the system thereby enabling the user of the system to verify the identity of the subject of the dictation. The executable instruction set may also be operable to notify the user of the system that a record having identifying indicia corresponding to the alpha-numeric indicia has not been found and to prompt the user to enter new alpha-numeric indicia, continue with the dictation process or terminate the dictation session.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 is a block diagram of a system for patient identification verification utilizing text to speech conversion and playback in accordance with at least one embodiment shown and described herein;

FIG. 2 is a flow diagram of the method of patient identification verification utilizing text to speech conversion and playback in accordance with at least one embodiment shown and described herein; and

FIG. 3 is a block diagram of a system for patient identification verification utilizing text to speech conversion and playback in accordance with at least one embodiment shown and described herein.

These and additional features provided by the embodiments of the present invention will be more fully understood in view of the following detailed description read in conjunction with the drawings.

### DETAILED DESCRIPTION

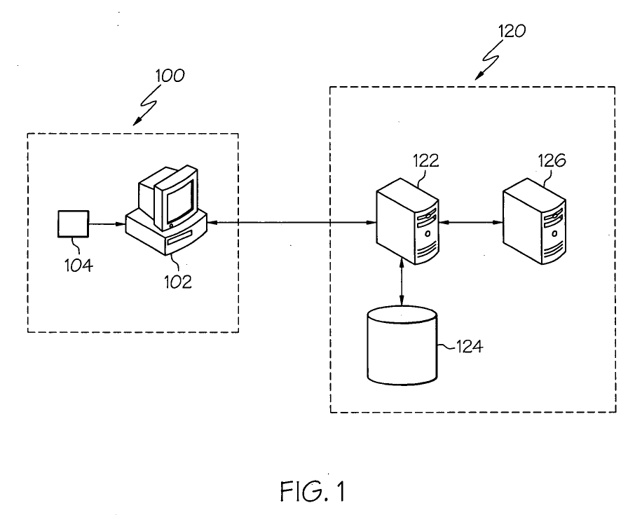

FIG. 1 is a block diagram depicting a system for verifying the identity of the subject of a dictation according to one embodiment shown and described herein. The system may generally comprise a computer and an input device. The system may be coupled to a records database. The system may be operable to receive input from a user which relates or is linked to the identity of a dictation subject, query the records database using the input information for a record having corresponding information, and, when a record is found, audibly communicate subject identifiers to the user of the system enabling the user to verify the identity of the subject of the dictation. The system and methods of using the system will be described in more detail herein.

FIG. 1 depicts a block diagram of a system 100 according to one embodiment shown and described herein. The system 100 is operable to receive dictation from a user by digitally recording the speech of a user and storing the speech as a digital audio file. The digital audio file of the user's speech may be transcribed to text. The system 100 generally comprises a computer 102 coupled to an input device 104. The computer 102 may be a workstation (e.g., a desktop, tablet or laptop computer), a computer server capable of receiving telephonic input, a dedicated dictation workstation (e.g., a desktop, tablet or laptop computer which is only operable to run dictation software) or a similar electronic device capable of executing an instruction set contained on a computer readable medium which may be installed on the computer 102. The software stored on the computer 102 may enable the computer to perform the method of verifying the identity of the subject of a dictation described herein.

In one embodiment, the input device 104 coupled to the computer 102 may comprise a microphone which permits a user of the system to verbally input information into the system. The microphone may be a handheld microphone, wireless microphone, or a desktop microphone, such as a microphone attached to a desktop computer. Alternatively, the microphone may be integral with the computer, such as when the computer 102 is a laptop, tablet or desktop computer. In this embodiment, where the input device 104 comprises a microphone, the system 100 may also include one or more audio speakers (not shown) coupled to the computer 102.

It should be noted that coupled, as used herein, generally refers to various components (e.g., computer 102, input device 104, records database 120, etc.) being operatively connected to other components such that electronic and/or electromagnetic signals may be propagated between the components. Further, coupled should be understood to include both external operative connections (e.g., the computer 102 may be coupled to an external input device 104 as shown in FIG. 1) and internal operative connections (e.g., the computer 102 may be coupled to a records database that is internal to the computer 102 (discussed further herein)).

In another embodiment, the input device 104 may be a keyboard, a pointing device (e.g., a mouse or similar pointing device), a numeric or alpha-numeric keypad, or a similar input device which may be used to input numeric or alpha-numeric characters into the computer 102. In this embodiment, the system 100 may also include one or more audio speakers (not shown) coupled to the computer.

In yet another embodiment, the input device 104 may comprise a telephone or a wireless device coupled to the computer 102 via a telephone network. The alpha-numeric key pad of the telephone or wireless device may be used to input alpha-numeric characters into the computer 102. Alternatively, the telephone or wireless device may be used to verbally input information into the computer 102.

While the embodiment of the system 100 shown in FIG. 1 is depicted with only one input device 102, it should be understood that the system 100 may have multiple input devices. For example, when the system 100 comprises a computer such as a laptop computer, a tablet computer, or a desktop computer, the system may include multiple input devices including a keyboard, a microphone, a pointing device etc.

As noted herein, the system 100 may be coupled to a records database 120. In one embodiment, as shown in FIG. 1, the records database 120 may comprise a separate computer such as the records computer 122. The records computer 122 may be coupled to an electronic file storage device 124. The system 100 is coupled to the records database 120 by electronically coupling the computer 102 to the records computer 122 through a network connection or similar interface. The connection between the system 100 and the record database 120 allows the system to initiate a search of the records stored in the storage device 124 of the records database 120 which, in turn, facilitates the method for verifying the identity of the subject of a dictation shown and described herein.

In another embodiment (not shown) the records database may be located within the system 100. For example, in one embodiment the records database may be directly coupled to the computer 102 such as when the records database is a storage device connected to the computer via an external or network connection. In another embodiment, the records database may be integral with the computer 102 as a disk drive internally located and coupled to the computer 102.

As will be described in more detail, the methods and systems shown and described herein may be used in a variety of industries including the legal, business, accounting, law enforcement and medical industries. When the methods and systems are used in the medical industry, the records database 120 may further comprise a healthcare information server or scheduling system server 126 which is coupled to the records computer 122, as shown in FIG. 1. The healthcare information server 126 may be used to input patient information (e.g., patient names, dates of birth, social security numbers, medical record numbers, visit information, etc.) into the storage device 124 of the records database 120. Access to the storage device 124 of the records database 120 by the healthcare information server 126 is facilitated through the records computer 122. However, it should be understood that the healthcare information server 126 is an optional component and that access to records stored in the records database 120 may also be had using the computer 102 of the system 100.

While specific reference has been made herein to the use of a healthcare information server 126 to input patient information into the records database 120, it should be understood that information may be entered into a records database 120 using a variety of different methods. Furthermore, the records database may take on a variety of different forms and/or configurations and may comprise various other components and structures. Accordingly, no particular limitation is intended as to the exact form and structure of the records database 120 and it should be understood that any database configuration now known or subsequently developed and capable of storing and retrieving records in a digital format may be used in conjunction with the methods and systems of the present invention.

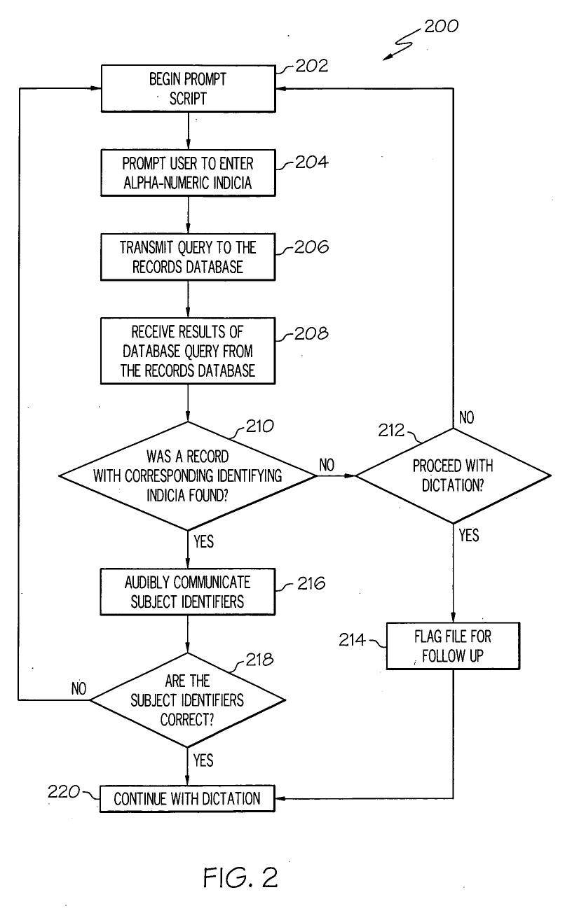

Referring now to FIGS. 1 and 2, the computer 102 may include software which controls the computer 102 and facilitates the method of the present invention. FIG. 2 shows a flow diagram of the software processes 200 used in the method for verifying the identity of the subject of a dictation according to one embodiment shown and described herein. When a dictation session is started on the computer 102 of the system 100, a prompt script is initiated at step 202. The prompt script is an instruction set in the form of a compiled or interpreted code that controls the flow of the process 200. At step 204 the user is prompted to enter alpha-numeric indicia related to the identity of the subject of the dictation. The prompt may be visual such as when the prompt appears on a screen associated with the computer 102, and/or audible, such as when the prompt is played over speakers or a hand set. For example, when the system 100 is being used in the medical industry, such as when the system is being used to dictate a medical report for a specific patient, the alpha-numeric indicia related to the identity of the subject of the dictation and entered by the user may be arbitrary or random alpha-numeric indicia which have been previously assigned or linked to the identity of the patient and/or the patient's medical records. These arbitrarily or randomly assigned indicia related to the identity of the subject of the dictation may include medical record numbers, patient account numbers, order number, token IDs, visit IDs, or the like. Alternatively, the alpha-numeric indicia related to the identity of the subject of the dictation may include non-random alpha-numeric indicia, such as patient name, date of birth, social security number, patient visit date, address, telephone number or the like. Alternatively, the alpha-numeric indicia related to the identity of the subject of the dictation may include any combinations and/or portions of such arbitrarily, randomly assigned, or non-random indicia Accordingly, it should be understood that the alpha-numeric indicia related to the identity of the subject of the dictation may be assigned alpha-numeric indicia unrelated to the actual identity of the subject of the dictation or non-random alpha-numeric indicia at least partially related to the identity of the subject of the dictation.

The alpha-numeric indicia are entered into the computer 102 with the input device 104. For example, in one embodiment, when the input device 104 is a keyboard or keypad, the alpha-numeric indicia may be typed into the input device 104 which inputs the information into the computer. In another embodiment, input device 104 is a telephone and the keypad is used to enter alpha-numeric indicia which inputs the information into a computer capable of interacting with a telephonic device. Where the input device is a microphone or telephone, the alpha-numeric indicia may be spoken into the input device 104 which inputs the information into the computer 102. In this embodiment, the computer 102 receives audible information from the input device 102 and converts the audible information into text or another suitable format that may be read by the computer 102 using speech to text software.

In step 206 a query based on the entered alpha-numeric indicia is transmitted from the computer 102 to the records computer 122 of the records database 120. The transmitted query is received by the records computer 122 which prompts the records computer 122 to perform a search of the records database, specifically the file storage device 124 of the records database 120, for any records having identifying indicia corresponding to the entered alpha-numeric indicia. For example, when the system 100 is being used for medical dictation, the records database 120 and, more specifically, the file storage device 124, may be pre-populated with patient related information including subject identifiers and identifying indicia. In one embodiment, the identifying indicia may be randomly or arbitrarily assigned and/or linked to the subject identifiers such that the identity of the subject is obfuscated for purposes of patient privacy. In this embodiment, the identifying indicia may generally include the same type of information as discussed herein with respect to the alpha-numeric indicia including arbitrarily or randomly assigned indicia may include medical record numbers, patient account numbers, order number, token IDs, visit IDs, or the like. In another embodiment, the identifying indicia may include non-random identifying indicia, such as name, date of birth, social security number, patient visit date, address, telephone number or the like. In yet another embodiment, the identifying indicia may comprise a combination of arbitrarily assigned identifying indicia with non-random identifying indicia, and/or any portion of such indicia. For example, a randomly assigned multi-digit number may be used in conjunction with a patient's initials for purposes of identifying indicia. The records contained in the records database may be indexed according to the identifying indicia.

Using the entered alpha-numeric indicia, the records computer 122 searches the file storage device 124 of the records database 120 for a record having identifying indicia which correspond to the alpha-numeric indicia entered by the user. When a record is found with identifying indicia corresponding to the entered alpha-numeric indicia, subject identifiers contained in the record are transmitted back to the system 100. The subject identifiers may include the name of the subject and/or other identifying characteristics, or combinations and/or portions thereof. For example, when the system is used for medical dictation, the subject identifiers may include information such as the name of the patient, date of birth of the patient, or similar information. In one embodiment, the subject identifiers transmitted from the records computer 122 to the computer 102 are contained in a digital audio file. In another embodiment, the subject identifiers transmitted from the records computer 122 to the computer 102 are text data or a similar, non-audio data format.

When a record having identifying indicia corresponding to the entered alpha-numeric indicia is not found, the records computer 122 transmits a notification to the computer 102 indicating that the records database 120 does not contain a file having corresponding indicia.

In a next step 208, after the records database 120 has been queried, the computer 102 receives the results of the query from the records computer 122. Thereafter, in step 210, the computer 102 assesses the results of the query and determines if a record with corresponding identifying indicia has been found. When a record having corresponding identifying indicia has not been found, the computer 102 notifies the user of the system 100 that a corresponding record has not been found and the method proceeds to step 212. For example, in one embodiment the computer 102 may play an audio message (either through audio speakers coupled to the computer 102 or through the telephone or wireless device) indicating that no record was found for the entered alpha-numeric indicia. Alternatively, the computer 102 may display the message to the user on a screen operatively coupled to the computer 102. The computer 102 may then prompt the user to either a) proceed with the dictation or b) reenter the alpha-numeric indicia. These prompts may be visual (e.g., on a screen coupled to the computer) or audible (e.g., on speakers coupled to the computer or the input device). The system 100 may be configured to allow the user to respond to such prompts either orally via a microphone or handset, or by typing in a response on a keypad, keyboard, or similar device. If the user elects to reenter the alpha-numeric indicia, the method returns to step 202. If the user elects to continue with the dictation process, the method proceeds to step 214. In step 214 the dictation may be flagged. Generally, flagged, as used herein, means that dictation (e.g., the digital audio file containing the dictation) is stored or routed and/or a property associated with the dictation is set, so as to indicate whether the alpha-numeric indicia correspond to the identifying indicia from the records database and/or the subject identifiers. Accordingly, when the user elects to continue with the dictation process when the alpha-numeric indicia do not match the identifying indicia and/or the subject identifiers, the dictation is flagged to indicated that the alpha-numeric indicia do not match the identifying indicia and/or the subject identifiers. Thereafter, the method proceeds to step 220 and the user proceeds with the dictation process. After the dictation is complete, the completed dictation may be suspended in a queue or appropriately routed for further review and correlation to an existing patient record based on the flag.

Alternatively, in another embodiment, when the alpha numeric indicia do not correspond to the identifying indicia of a record in the records database 120, the user is notified that a corresponding record has not been found and the user is permitted to continue with the dictation process without responding to a prompt and the dictation is flagged to indicate that the identity of the subject of the dictation has not been verified.

Referring again to step 210, when a record having identifying indicia corresponding to the entered alpha-numeric indicia has been identified in the query of the records database, the method proceeds to step 216 and the subject identifiers received by the computer 102 from the records computer 122 are audibly communicated to the user.

In one embodiment, when the subject identifiers are contained in a digital audio file transmitted to the computer from the records computer 122, the computer 102 plays the audio file of the subject identifiers through audio speakers coupled to the computer or through the handset of a telephone or similar wireless device.

In another embodiment, the computer 102 is operable to convert text data to speech, such as when the subject identifiers are text data or similar non-audio data. For example, the text data may first be converted to an audio file with text to speech software. In one embodiment, the text to speech software is loaded on the computer 102 (as shown in FIG. 1) and the text data of the subject identifiers are locally converted (e.g., on the computer 102) from text to speech and audibly communicated to the user.

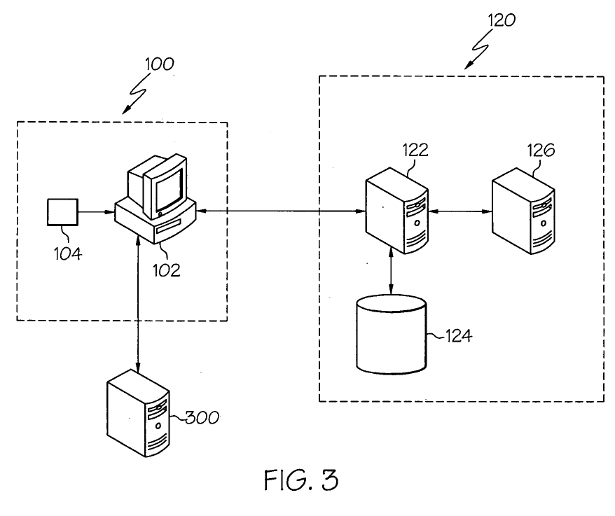

Referring now to FIG. 3, in yet another embodiment, text to speech software and/or a text to speech engine may be located on a separate server 300 to which the computer 102 is coupled. When text data containing the subject identifiers are received by the computer 102, the computer is operable to transmit the text data containing the subject identifiers to the text to speech server 300 which converts the text data to a digital audio file. The text to speech server 300 returns the digital audio file containing the subject identifiers to the computer 102 which plays the digital audio file to the user, as described above.

It should now be understood that the computer 102 may be operable to convert text data to an audio file either locally or through a attached device coupled to the computer 102 such as a server operable to convert text to speech or the like.

Referring again to FIGS. 1 and 2, in one example, when the system 100 is used for medical dictation, the subject identifiers may include the name of the patient and the patient's data of birth such as “John Smith” and “Nov. 11, 1969,” respectively. Accordingly, the audible communication to the user may state “patient John Smith date of birth Nov. 11, 1969.” In another embodiment, the subject identifiers may also include the date of the visit and the audible communication to the user may state “patient John Smith visit date of Aug. 20, 2008.” It should, however, be understood that the subject identifiers may include any combination of information and/or portions of information which would suffice to indicate the identity of the subject to a user and, as such, no particular limitation as to the type and or amount of information contained in the subject identifiers is intended unless otherwise specified.

Upon hearing the audible communication of the subject identifiers, the user may determine whether the subject identifiers correspond to the subject of the dictation. If the audiblized subject identifiers match the subject of the dictation, the correct record has been retrieved and any subsequent dictation will be properly stored with the correct record.

In order to verify the identity of the subject of the dictation, the method proceeds to step 218. In this step, the user is visually or audibly prompted to confirm if the audiblized subject identifiers correspond to the subject of the dictation. If the user indicates that the audiblized subject identifiers are a correct match, the method proceeds to step 220 and the user continues with the dictation process. If the subject identifiers are not a correct match, the method may return to step 202 and the prompt script begins again. For example, in one embodiment, where the system 100 is being used for medical dictation, an audio prompt may be played through the speakers or handset (or a text prompt may be displayed on a screen of the computer 102) such as “Press 1 to confirm the identity of the patient and continue dictating; press 2 to re-enter the alpha-numeric indicia.” In this example, if 2 is pressed, the user may be prompted to re-enter the alpha-numeric indicia and the process 200 begins again. If 1 is pressed, the user may continue with the dictation process. The system 100 may be configured to allow the user to respond to such prompts either orally via microphone or handset, or by typing in a response on a keypad or similar device. Alternatively, the system could audibly communicate the subject identifiers and allow the user to continue dictating without responding to a confirmation prompt. Thereafter, the user may select to restart the process 200 at anytime during or after the dictation process. Alternatively, the method may allow the user to proceed with the dictation process when the audiblized subject identifiers are not a correct match and have the resulting dictation flagged for further review.

In another embodiment, when the user indicates that the audiblized subject identifiers correspond to the identity of the subject of the dictation, the dictation is flagged to indicate that the user has verified the identity of the subject of the dictation.

While specific embodiments describe the method of verifying the identity of the subject of the dictation at the beginning of the dictation process, it should be understood that the order of various prompts to the user and possible responses from the user may be configurable and may be re-organized for a particular user's work flow needs. For example, the method of verifying the identity of the subject of the dictation may be performed at the beginning of a dictation session or after the dictation is completed. Alternatively or additionally, the system 100 may be configured such that the user may elect to verify the identity of the subject of the dictation at any time during the dictation process.

In one embodiment of the system 100 depicted in FIG. 1, the system is used to dictate medical reports and the user may interface with the system 100 through a telephonic interface (e.g., the input device 104 is a telephone or similar wireless device). The system prompts the user to enter alpha-numeric indicia related to the identity of a patient. The user enters the alpha-numeric indicia using the keypad of the telephone, or by speaking through the handset or microphone. When the alpha-numeric indicia are spoken, the computer 102 converts the speech to text with speech to text software either contained within the computer 102 or operatively associated with the computer 102. The system 100 then uses the alpha-numeric indicia provided by the user to query the database for a patient record with the corresponding identifying indicia. If no match is found, an audio message is played back to the user by the computer 102 stating that no match has been found and prompting the user to reenter the alpha-numeric indicia. Alternatively, the system may be configured to allow the user to continue with the dictation process, with or without flagging the dictation with a message or warning indicating that the alpha-numeric indicia entered by the user are not valid.

If a match is found, associated information about the patient (e.g., subject identifiers), such as patient name and date of birth, are transmitted from the records database 120 as text data. Text to speech software operatively associated with the system 100 converts the text data to an audio file. The audio file is played back to the user by the computer 102. The system 100 then plays an audio message prompting the user to verify that the provided patient name and other information matches the patient name for the medical record that is being dictated. If the user provides a positive response, either orally via the handset or microphone or manually by using the keypad of the telephone, the dictation session will continue; if the user provides a negative response, an audio message will prompt the user to reenter the alpha-numeric indicia and the process will repeat. Alternatively, the system may permit the user to continue with the dictation process without requiring the user to verify a match, with or without flagging the dictated report to indicate that the user did not verify the match.

Using the methodology described herein, a user dictating a report may correlate the report with the correct identity of the subject of the dictation at the time of dictation. No information that discloses the identity of the subject, such as birth date, name, etc., needs to be included or associated with the dictated report which may be subsequently released to a transcriptionist. In addition, because the user verifies the identification of the subject at the time of dictation, the user need not dictate specific information related to the identity of the subject into the dictation audio file for the transcriptionist to verify. Moreover, it is not necessary for the transcriptionist to access information related to the identity of the subject during transcription, thereby maintaining the confidentiality of the identity of the subject during the transcription process. These aspects of the method are particularly advantageous when the method is used to dictate medical reports where patient confidentiality and privacy are a primary concern. The method thereby serves as a valuable tool for complying with federal, state and local privacy and confidentiality laws such as the Health Insurance Portability and Accountability Act (HIPPA).

While specific examples discussed herein are directed to using the dictation method and system described herein to dictate medical reports, it should be understood that the method may be used in various other industries and fields of endeavor such as business, law, accounting, law enforcement and the like. Accordingly, no particular limitation is intended by the recited examples.

Further, particular embodiments and aspects of the present invention have been illustrated and described herein, various other changes and modifications can be made without departing from the spirit and scope of the invention. Moreover, although various inventive aspects have been described herein, such aspects need not be utilized in combination. It is therefore intended that the appended claims cover all such changes and modifications that are within the scope of this invention.

What is claimed is:

1. A method for verifying an identity of a subject of a dictation process in a system operable to receive dictation from a user comprising an input device and a computer coupled to a records database, the method comprising:
entering alpha-numeric indicia into the system with the input device, wherein the entered alpha-numeric indicia are related to the identity of the subject of the dictation;
transmitting the entered alpha-numeric indicia to the records database;
receiving subject identifiers associated with a record in the records database when the entered alpha-numeric indicia correspond to identifying indicia of the record; and
audibly communicating the received subject identifiers of the record to a user of the system thereby enabling the user to verify the identity of the subject of the dictation.

2. The method of claim 1 further comprising:
searching the records database for a record having identifying indicia corresponding to the entered alpha-numeric indicia; and
transmitting subject identifiers associated with the record from the database to the system when a record having identifying indicia corresponding to the received alpha-numeric indicia is found.

3. The method of claim 1 further comprising notifying the user of the system when a record having corresponding alpha-numeric indicia is not found.

4. The method of claim 3 further comprising prompting the user to reenter the alpha-numeric indicia when a record having corresponding alpha-numeric indicia is not found.

5. The method of claim 3 further comprising prompting the user to proceed with the dictation process when a record having corresponding alpha-numeric indicia is not found.

6. The method of claim 5 wherein, when the user proceeds with the dictation process, the dictation is flagged.

7. The method of claim 1 further comprising prompting the user of the system to verify that the audibly communicated subject identifiers correspond to the identity of the subject of the dictation.

8. The method of claim 7 further comprising prompting the user of the system to reenter the alpha-numeric indicia when the user indicates that the audibly communicated subject identifiers do not correspond to the subject of the dictation.

9. The method of claim 7 further comprising prompting the user to proceed with the dictation process when the user indicates that the audibly communicated subject identifiers do not correspond to the subject of the dictation.

10. The method of claim 9 further comprising flagging the dictation.

11. The method of claim 7 further comprising continuing with the dictation process when the user indicates that the audibly communicated subject identifiers correspond to the subject of the dictation.

12. The method of claim 11 further comprising flagging the dictation.

13. The method of claim 1 wherein the subject identifiers received by the system are text data and the method further comprises converting the text data containing the subject identifiers to an audio file.

14. A method for verifying an identity of a subject of a dictation, the method comprising:
receiving alpha-numeric indicia related to the identity of the subject of the dictation;
searching a records database for a record having identifying indicia corresponding to the received alpha-numeric indicia; and
transmitting subject identifiers associated with the record to a system when a record having identifying indicia corresponding to the received alpha-numeric indicia is found, wherein the system is operable to:
receive dictation from a user; and
audibly communicate the subject identifiers to the user.

15. The method of claim 14 further comprising transmitting a notification to the system when a record having identifying indicia corresponding to the alpha-numeric indicia is not found.

16. A system operable to receive dictation from a user and to verify an identity of a subject of a dictation during a dictation process, the system comprising an input device and a computer, wherein:
the input device is coupled to the computer and is operable to input alpha-numeric indicia received from a user into the computer, wherein the alpha-numeric indicia are related to the identity of the subject of the dictation;
the computer is coupled to a records database and is operable to:
transmit the alpha-numeric indicia from the input device to the records database and thereby initiate a search of the records database for a record having identifying indicia corresponding to the alpha-numeric indicia received from the input device;
receive subject identifiers associated with a record in the records database when the alpha-numeric indicia correspond to identifying indicia associated with the record; and
audibly communicate the subject identifiers associated with the record to the user thereby enabling the user of the system to verify the identity of the subject of the dictation or notify the user of the system when a record having identifying indicia corresponding to the alpha-numeric indicia is not found.

17. The system of claim 16 wherein, when a record having corresponding alpha-numeric indicia is not found, the computer is further operable to:
prompt the user to reenter the alpha-numeric indicia; and
receive an input from the user indicative of the user selecting to reenter the alpha-numeric indicia.

18. The system of claim 16 wherein, when a record having corresponding alpha-numeric indicia is not found, the computer is further operable to:
prompt the user to continue with the dictation process; and
receive an input from the user indicative of the user selecting to continue with the dictation process.

19. The system of claim 18 wherein the computer is further operable to flag the dictation.

20. The system of claim 16 wherein the computer is further operable to:
prompt the user to verify that the audibly communicated subject identifiers correspond to the identity of the subject of the dictation; and
receive an input from the user indicative of whether the subject identifiers correspond to the identity of the subject of the dictation.

21. The system of claim 20 wherein the computer is further operable to:
prompt the user of the system to reenter the alpha-numeric indicia when the received input is indicative of the subject identifiers not corresponding to the identity of the subject of the dictation; and
receive an input from the user indicative of the user selecting to reenter the alpha-numeric indicia.

22. The system of claim 20 wherein the computer is further operable to:
prompt the user of the system to continue with the dictation process when the received input is indicative of the subject identifiers not corresponding to the identity of the subject of the dictation; and
receive an input from the user indicative of the user selecting to continue with the dictation process.

23. The system of claim 22 wherein the computer is further operable to flag the dictation.

24. The system of claim 20 wherein the computer is further operable to continue with the dictation process when the received input is indicative of the subject identifiers corresponding to the identity of the subject of the dictation.

25. The system of claim 20 wherein the computer is further operable to flag the dictation.

26. The system of claim 16 wherein the received subject identifiers are text data and the computer is operable to convert the text data to an audio file and play the audio file.

27. A computer readable medium comprising an executable instruction set for use in conjunction with a system operable to receive dictation from a user comprising an input device and a computer wherein, when the executable instruction set is executed by the computer, the executable instruction set causes the computer to:
prompt a user to enter alpha-numeric indicia into the input device, wherein the alpha-numeric indicia are related to the identity of a subject of a dictation;
transmit the entered alpha-numeric indicia to a records database thereby initiating a search of the records database for a record having identifying indicia corresponding to the entered alpha-numeric indicia;
receive subject identifiers associated with a record in the records database when the alpha-numeric indicia correspond to identifying indicia associated with the record; and
audibly communicate subject identifiers associated with the record when a record having identifying indicia corresponding to the alpha-numeric indicia is found thereby enabling a user of the system to verify the identity of the subject of the dictation or notify a user of the system when a record having identifying indicia corresponding to the entered alpha-numeric indicia is not found.

28. The computer readable medium of claim 27 further comprising causing the computer to prompt the user to reenter the alpha-numeric indicia when a record having corresponding identifying indicia is not found.

29. The computer readable medium claim 27 further comprising causing the computer to prompt the user to continue with the dictation process when a record having corresponding identifying indicia is not found.

30. The computer readable medium of claim 29 further comprising causing the computer to flag the dictation.

31. The computer readable medium of claim 27 further comprising causing the computer to prompt the user of the system to verify that the audibly communicated subject identifiers correspond to the identity of the subject of the dictation process.

32. The computer readable medium of claim 31 further comprising causing the computer to prompt the user of the system to reenter the alpha-numeric indicia when the user indicates that the audibly communicated subject identifiers do not correspond to the subject of the dictation.

33. The computer readable medium of claim 31 further comprising causing the computer to prompt the user of the system to continue with the dictation process when the user indicates that the audibly communicated subject identifiers do not correspond to the subject of the dictation.

34. The computer readable medium of claim 33 further comprising causing the computer to flag the dictation.

35. The computer readable medium of claim 31 further comprising causing the computer to continue with the dictation process when the user indicates that the audibly communicated subject identifiers correspond to the subject of the dictation.

36. The computer readable medium of claim 35 further comprising causing the computer to flag the dictation.

37. The computer readable medium of claim 27 further comprising causing the computer to convert the received subject identifiers to an audio file.
